(19) United States
(12) Patent Application Publication
(10) Pub. No.: US 2009/0255104 A1
(43) Pub. Date: Oct. 15, 2009

(54) Simplified generator removal operation for rotor removal of center generator in a single shaft combined cycle machine

(75) Inventors: John M. Gillivan, Albany, NY (US); Richard Allen Bradt, Ballston Lake, NY (US); Douglas M. Wolter, Cumming, GA (US); Jeffrey L. Farrow, Snellville, GA (US)

Correspondence Address: NIXON & VANDERHYE P.C., 901 NORTH GLEBE ROAD, 11TH FLOOR, ARLINGTON, VA, 22203, US

(73) Assignee: GENERAL ELECTRIC COMPANY, Schenectady, NY (US)

(21) Appl. No.: 12/081,073

(22) Filed: Apr. 10, 2008

(51) Int. Cl. H02K 15/02

(52) U.S. Cl. 29/426.1

(57) ABSTRACT

A method of removing a rotor from a generator of a single shaft combined cycle machine comprising a gas turbine, generator and steam turbine axially aligned, the method comprising: disengaging fasteners securing stator support feet of the generator to a foundation thereof; vertically raising the generator above the foundation; disposing temporary supports on each lateral side of the generator, beneath the stator support feet; securing the stator support feet to the temporary support columns; installing a maintenance personnel access platform over the steam turbine, axially adjacent the generator; and removing the rotor from the generator to the access platform.

### BACKGROUND OF THE INVENTION

Removal of the generator on a single shaft combined cycle machine for infrequent maintenance and inspection historically has required removal of the entire generator from its location on the pedestal, movement to another location in the plant and finally, removal of the rotor. This requires equipment and space, and compliance with various codes and standards while in the maintenance position.

Thus, in the past, maintenance of the generator has required lifting equipment that cannot only lift but can translate the entire generator to the side and lower it either to the floor or to a support structure. This problem may be addressed by providing an overhead crane that is capable of carrying the full load of the generator and moving it to the floor, but at the additional cost of a crane having that lifting and translating capability.

### BRIEF DESCRIPTION OF THE INVENTION

The present invention provides a simplified generator removal operation wherein the generator is vertically lifted from the pedestal, temporary supports are disposed between the generator and the pedestal to support the generator in its elevated position, an access platform is installed over the steam turbine and adjacent to the elevated generator, so that the field (rotor) can be removed from the stator onto the maintenance access platform.

Thus, the invention may be embodied in a method of removing a rotor from a generator of a single shaft combined cycle machine comprising: disengaging fasteners securing stator support feet of the generator to a foundation thereof; vertically raising the generator above the foundation; disposing temporary supports on each lateral side of the generator, beneath the stator support feet; securing the stator support feet to the temporary supports; installing a maintenance personnel access platform over the steam turbine, longitudinally adjacent to the generator; and removing the rotor from the generator to the access platform.

### BRIEF DESCRIPTION OF THE DRAWINGS

FIG. 1 is a schematic perspective view of a generator disposed on a pedestal foundation and decoupled from adjacent gas and steam turbines;

FIG. 2 is a schematic end view of an elevated generator according to the method of the invention;

FIG. 3 is a schematic perspective view of a rotor being removed from a generator in an example embodiment of the invention; and

FIG. 4 is a schematic elevational view of the single shaft combined cycle machine with disengaged and elevated generator and removed rotor according to an example embodiment of the invention.

### DETAILED DESCRIPTION OF THE INVENTION

As noted above, conventional removal of the generator of a single shaft combined cycle machine for its infrequent maintenance and inspection has required removal of the entire generator from its location on the pedestal, movement to another location in the plant and, finally, removal of the rotor. In accordance with an example embodiment of the invention, rather than providing equipment to lift and translate the generator, the generator is vertically lifted from its foundation, for example, using a hydraulic gantry lifting system. The generator is then temporarily supported in that elevated disposition so that the rotor can be removed without moving the generator to another location. This reduces the time and expense to remove the rotor and reduces plant capital cost, since a second location for maintenance activities is not required. To support the generator during the maintenance operation, in an example embodiment of the invention, the existing generator pedestal structure is used to support the generator, with temporary supports being placed between the pedestal and the generator feet. A temporary platform is then placed over the steam turbine to allow access to the elevated generator for rotor removal activities. The field can then be removed to the temporary platform using the existing building overhead crane.

The field removal process according to an example invention will now be described in greater detail with reference to the accompanying drawings.

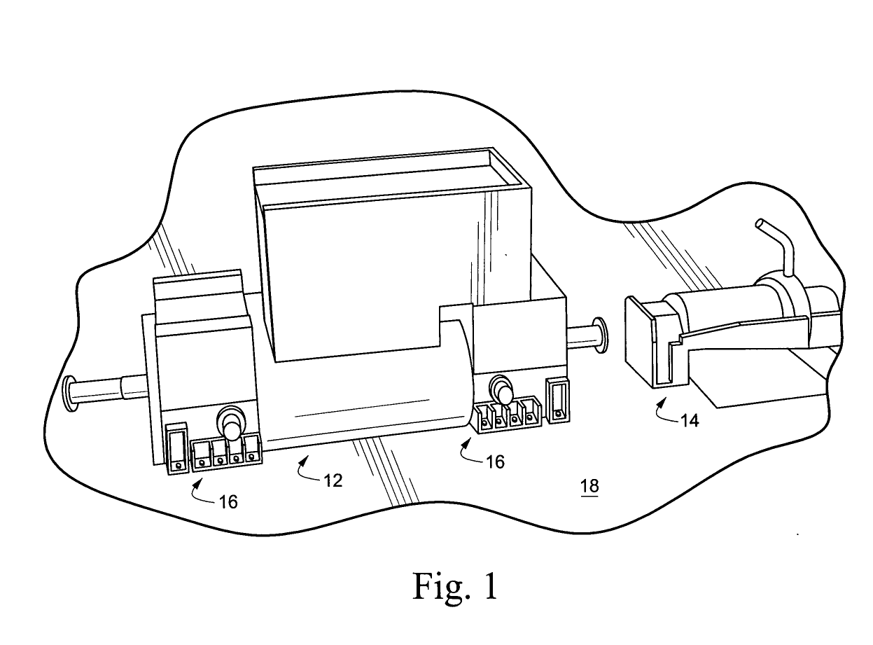

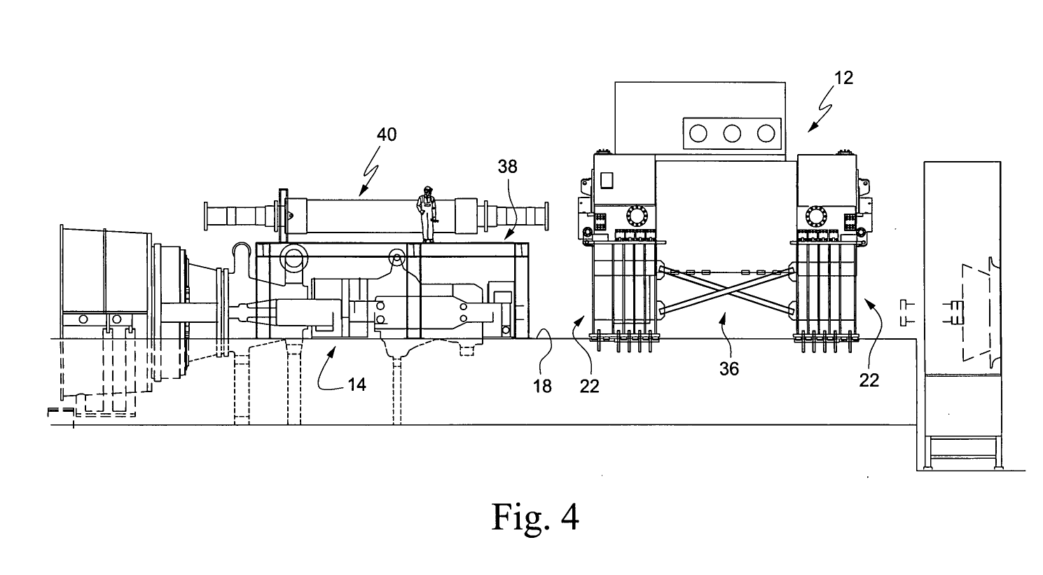

As an initial step, while the power train is on turning gear to cool down the steam turbine, the generator acoustic walls and enclosures are removed, including the load compartment and associated acoustic enclosure, for exposure of the generator 12 and steam turbine 14 structures. The unit is then purged of gases and all generator electrical and mechanical interfaces are disconnected. The collector compartment (not shown) is removed. Then the steam turbine end coupling guards are removed and coupling separated, and the gas turbine end coupling guards are removed and the coupling separated. The foundation hardware is then removed from the stator feet 16, so that the generator can be moved relative to the pedestal 18. Thus, as shown in FIG. 1, the generator 12 is decoupled from all surrounding structures, including the gas turbine 20 (FIG. 4), the steam turbine 14 (FIGS. 1 and 4) and the pedestal or foundation platform 18 (FIG. 4) so that it can be displaced vertically.

In preparation for supporting the generator after lifting, four temporary support columns 22 are positioned near the generator support locations. A temporary hydraulic gantry lifting system 24 is then set up. As illustrated, a plurality of hydraulic lifts 26 are disposed about the generator, in the illustrated example at four locations, two on each side of the generator. The hydraulic lifts 26 in the illustrated example have lift beams 28 extending between them over the generator. Suitable cabling 30, for example, extends downwardly in a loop from the lift beams 28 disposed above the generator 12, on each side of the generator, for engaging respective lift pins 32, projecting laterally from the generator 12.

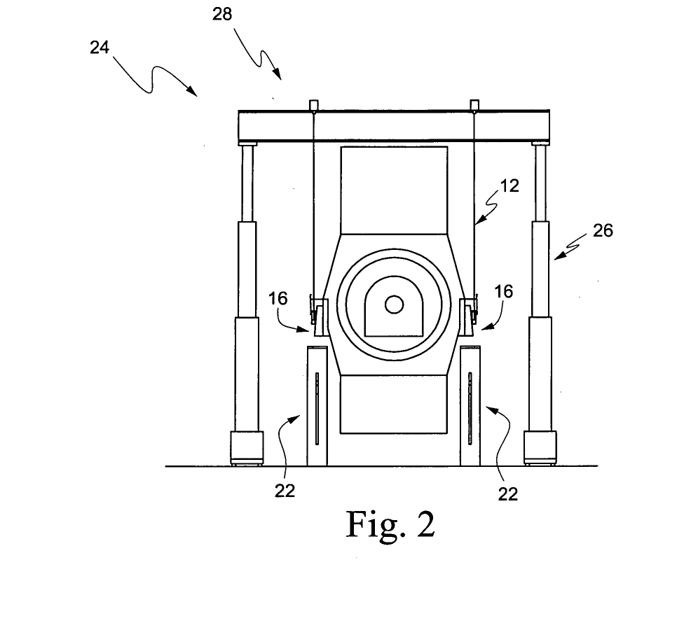

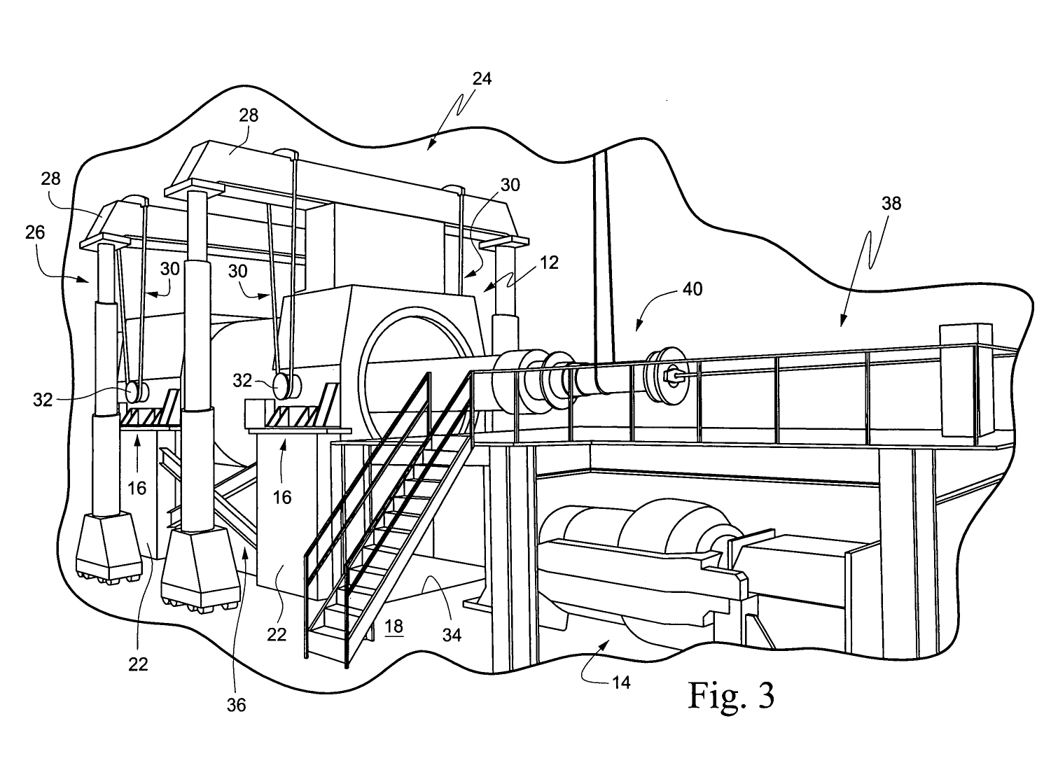

Once the hydraulic gantry lifting system is set up, the generator 12 is raised, in this example about 12 feet above the foundation 18, and the temporary support columns 22 are each moved to a location beneath the respective stator support feet 16 on each side of the generator, as illustrated in FIGS. 2 and 3. A temporary safety fence (not shown) is desirably disposed in surrounding relation to the generator pedestal hole 34 and a maintenance personnel access platform (not shown) is installed adjacent to the gas turbine 20. The generator is then lowered onto the temporary support columns 22 and bolted in place. In the illustrated example embodiment, the temporary support columns 22 at each longitudinal end of the generator are interconnected on each side of the generator by cross beam structures 36 for additional stability as illustrated in FIGS. 3 and 4. The generator end shield upper halves are removed and moved to the maintenance area and the lower halves are lowered and bolted to the stator at defined locations (not shown).

A maintenance personnel access platform 38 is then installed over the steam turbine 14 as illustrated in particular in FIGS. 3 and 4. The platform allows workers to access the field (rotor) 40 of the elevated generator 12 and the field can be removed from the generator using standard field removal procedures by translating it longitudinally as illustrated in FIGS. 3 and 4 on the maintenance platform 38, the fully removed rotor being illustrated in FIG. 4. As will be appreciated, field re-placement is effected by reversing the steps detailed hereinabove.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of removing a rotor from a generator of a single shaft combined cycle machine comprising a gas turbine, generator and steam turbine axially aligned, the method comprising:
disengaging fasteners securing stator support feet of the generator to a foundation thereof;
vertically raising the generator above the foundation;
disposing temporary supports on each lateral side of the generator, beneath the stator support feet;
securing the stator support feet to the temporary support columns;
installing a maintenance personnel access platform over the steam turbine, axially adjacent the generator; and
removing the rotor from the generator to the access platform.

2. A method as in claim 1, wherein said lifting comprises setting up a temporary hydraulic gantry lifting system to vertically lift the generator.

3. A method as in claim 1, wherein the generator is raised 12 feet above the foundation.

4. A method as in claim 1, wherein before the stator support feet are secured to the temporary supports, the generator is lowered onto the supports.
